(19) United States
(12) Patent Application Publication
(10) Pub. No.: US 2023/0049544 A1
(43) Pub. Date: Feb. 16, 2023

(54) SOLAR HYDROGEN METHOD

(71) Applicant: William Sheline, Farmington, MI (US)

(72) Inventor: William Sheline, Farmington, MI (US)

(21) Appl. No.: 17/565,118

(22) Filed: Dec. 29, 2021

Related U.S. Application Data
(60) Provisional application No. 63/231,863, filed on Aug. 11, 2021.

(51) Int. Cl. B01J 37/18; C01B 3/48; B01J 37/10

(52) U.S. Cl. CPC B01J 37/18; C01B 3/48; B01J 37/10; B01J 2208/00309

(57) ABSTRACT

Hydrogen is a useful carbon-neutral fuel that can be used in many applications. Unfortunately, hydrogen is hard to produce cost effectively without additional pollution from the production process. This invention solves the problem of producing hydrogen using a renewable low carbon source. This method uses high temperature heat from a concentrated solar power plant to generate steam from water. The steam can then be used with methane or another starter fuel to produce low carbon hydrogen. Additional steam can be added to boost the hydrogen to carbon ratios.

### FIELD OF THE INVENTION

This invention is a low carbon, low cost solution for hydrogen production.

### BACKGROUND

Existing devices using methane to produce hydrogen use methane both in the reforming process, and for heat. Due to methane being burned for heat, these devices produce higher carbon emissions and use more methane per hydrogen produced. Additionally, in existing devices, the reforming process is not optimal for producing the most hydrogen per unit of methane because doing so would require additional heat. The additional heat consumption would use more methane in the heating process than the value of the hydrogen.

### SUMMARY

This invention uses cost effective industrial methods combined with concentrated solar energy to produce hydrogen that requires less carbon pollution. Also, the invention reduces the marginal cost of hydrogen production by increasing the amount of hydrogen produced per methane input. In addition, waste heat from an existing concentrated solar power plant could reduce the marginal cost of hydrogen production. One embodiment of the invention is presented to show a hydrogen production method with lower carbon emissions than existing processes.

### BRIEF DESCRIPTION OF THE DRAWINGS

FIG. 1 shows an example of the method.

### DETAILED DESCRIPTION OF THE PREFERRED EMBODIMENT

The method has 6 steps. First, harness heat from a renewable source such as heat from a concentrated solar power tower or a geothermal plant. Second, use heat to produce steam, and preheat methane. Third, use additional heat to react steam and methane in a reformer. This can be done multiple times at various temperatures to maximize hydrogen output. Fourth, add steam to byproducts of previous step to generate additional hydrogen and reduce CO. Fifth, post process products. This could include condensing water from the mixture and removing CO, CO₂ products. Finally, store the hydrogen. This may require a compressor and storage tank. By following the above-listed steps, methane and water can be reformed into hydrogen using solar heat. This produces hydrogen with less methane than other methane reforming processes and reduces carbon emissions by using concentrated solar power (or another renewable heat source).

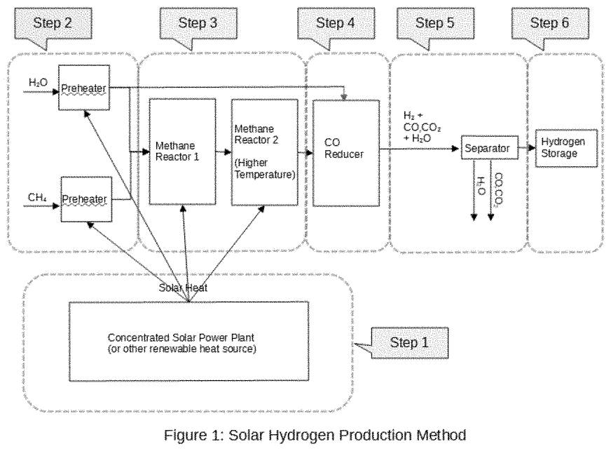

The method consists of 6 steps as shown in FIG. 1. The heat generated from step 1 is used in steps 2 and 3. Step 2 includes water input and methane input that are preheated for the reformer. Step 3 combines the methane and water in a reformer and heats the mixture to higher temperature. Heat is also added at constant temperature for the reformation process. This reformer can be divided into multiple temperature steps as necessary to optimize the heat exchange from a thermal storage fluid used to transfer heat from step 1. Once the mixture has been reacted for the optimal combination of temperatures and times, it is then supplied to a CO Reducer in step 4. Step 4 adds additional steam from step 2 to reduce the amount of CO and increase the amount of hydrogen in the byproducts. The reacted mixture from step 4 is then post processed in step 5 to remove water and carbon dioxide as necessary. In step 6, the water, CO, CO₂ can then be recycled (as necessary) and the hydrogen can be compressed and/or stored.

This method works to create hydrogen, carbon dioxide, and carbon monoxide from water, renewable heat and methane by the following steps. Step 1 harnesses thermal heat from the sun or other renewable source. In the case of a concentrated solar power plant, this can be done with a concentrated solar power tower. Concentrated solar power towers use a field of thousands of heliostat mirrors that focus sunlight on a single receiver to heat a transfer fluid to high temperatures (<1000 degrees C.). This fluid can later exchange heat to any of the components in steps 2 and 3 using a heat exchanger. Step 2 includes a heat exchanger and separate pressurized inputs for water and methane to heat water and methane to appropriate temperatures. In step 3, a heat exchanger exchanges heat to the combined mixture in a methane reactor. The design of the exchanger dictates the latency/temperature of the mixture in a continuous flow method (this could optionally be done with a batched process). In step 4, the byproducts from step 3 are added to additional steam from step 2 in a mixer. The mixer will control the flow rate of water and mixing process. Step 5 separates the products. A condenser can be used to remove water products. A CO and/or CO₂ scrubber can be used to remove carbon products. Step 6 is the hydrogen storage. A hydrogen tank can be used to store hydrogen by compressing the mixture with a compressor.

Necessary components include the renewable heat source (step 1), water and methane input sources (step 2), single methane reactor (step 3). Optional components include the preheating heat exchangers (step 2), additional methane reactors (step 3), CO reducing mixer (step 4), post processing equipment (step 5), and storage tank (step 6). Various flow meters, temperature measurement devices, pressure measurement devices, and active feed back controllers could be added at any stage. Compressors/heaters could be added at any stage to increase temperature or pressure of reactants. Storage could be added for the CO and/or CO₂ and water products to be used/sold as secondary products. The water could alternatively be recycled to the beginning of this cycle. This recycling could be done with addition of a pump.

Below are examples of alternative configurations that would be considered this invention. The concentrated solar power plant could be replaced with another solar heat supply system, or another renewable heat supply system (such as geothermal power). The input water and methane could be combined before the preheaters in step 2. Additionally, filters, desulferization equipment, or other equipment could be added to remove contaminates from the water or methane. Preheaters could be separated into multiple steps in step 2. The methane could be supplied from a bio-digestion source such as garbage gas or bio methane allowing offset of the carbon emissions. A heat exchanger could be added to recuperate heat from the products between steps 3 & 4 to heat the methane in step 2. The methane reactor could be separated into multiple steps at different temperatures and pressures. The CO Reducer (step 4) could be separated into multiple steps at different temperatures and pressures. This CO Reducer could also have multiple steam inputs. In step 5, the condenser, CO and/or CO₂ scrubber could be replaced with a different separation technology. The CO), products could be sequestered to prevent carbon emissions. By using this carbon sequestration with the bio methane, the process can become a negative carbon process. In step 6, the hydrogen could be stored with a different hydrogen storage technology (other than compressed hydrogen tank).

1. A method, comprising:
at least one renewable heat source including solar or geothermal power,
at least one steam (H₂O) and at least one methane (CH₄) input source; and
at least one reactor that reacts methane (CH₄) & steam (H₂O) into hydrogen (H₂), carbon monoxide (CO) & other byproducts using heat from the renewable heat source.

2. The method, as in claim 1, wherein said method is further comprising steam (H₂O) generated with heat from a renewable heat source or an outside heat source.

3. The method, as in claim 1 or 2, wherein said method is further comprising steam (H₂O) generated with recuperated heat from the methane (CH₄) reactor.

4. The method, as in claim 1, 2 or 3, wherein said method is further comprising of at least one reactor that mixes the hydrogen & carbon monoxide products from the methane reactor with steam (water and heat) to reduce CO and produce additional hydrogen.

5. The method, as in claim 1,2,3, or 4, wherein said method is further comprising methane preheated with recuperated heat from the methane (CH₄) reactor.

6. The method, as in claim 1, 2, 3, 4 or 5, wherein said method is further comprising methane (CH₄) generated with heat from a renewable heat source or an outside heat source.

7. The method, as in claim 1, 2, 3, 4, 5 or 6, wherein said method is further comprising methane (CH₄) from a bio-digestion process such as garbage gas or bio methane.

8. The method, as in claim 1, 2, 3, 4, 5, 6 or 7, wherein said method is further comprising carbon sequestration of carbon monoxide (CO) and other COₓ, products.

9. The method, as in claim 1, 2, 3, 4, 5, 6, 7 or 8, wherein said method is further comprising carbon scrubbers to remove carbon monoxide (CO) and other COₓ, products.
